(19) United States
(12) Patent Application Publication
(10) Pub. No.: US 2020/0079078 A1
(43) Pub. Date: Mar. 12, 2020

(54) PRINTER

(71) Applicants: Jun WATANABE, Tokyo (JP); Takeshi SHIKAMA, Kanagawa (JP); Yasunari HARADA, Kanagawa (JP)

(72) Inventors: Jun WATANABE, Tokyo (JP); Takeshi SHIKAMA, Kanagawa (JP); Yasunari HARADA, Kanagawa (JP)

(73) Assignee: Ricoh Company, Ltd., Tokyo (JP)

(21) Appl. No.: 16/533,969

(22) Filed: Aug. 7, 2019

(30) Foreign Application Priority Data
Sep. 10, 2018 (JP) 2018-168651
Feb. 18, 2019 (JP) 2019-026266
Jun. 28, 2019 (JP) 2019-120678

(51) Int. Cl. B41J 2/045; B41J 3/36

(52) U.S. Cl. CPC B41J 2/04508; B41J 3/36; B41J 2/0458

(57) ABSTRACT

A printer includes a housing, a recording device disposed on a bottom of the housing and having a reference position, a sensor configured to detect a movement amount of the recording device, and circuitry configured to set a start position to a different position from the reference position in a scanning direction in response to a print start instruction, and cause the recording device to start print processing at the set start position, based on the movement amount detected by the sensor.

### CROSS-REFERENCE TO RELATED APPLICATIONS

This patent application is based on and claims priority pursuant to 35 U.S.C. § 119(a) to Japanese Patent Application Nos. 2018-168651, filed on Sep. 10, 2018, 2019-026266, filed on Feb. 18, 2019, and 2019-120678, filed on Jun. 28, 2019, in the Japan Patent Office, the entire disclosure of each of which is hereby incorporated by reference herein.

### BACKGROUND

### Technical Field

The present disclosure relates to a printer.

### Description of the Related Art

As laptop computers (e.g., personal computers) become compact and smart devices smartphones) spread rapidly, compact mobile printers are strongly desired.

To meet such a demand, there are proposed mobile printers in which a recording medium conveyance system is omitted so that ink is applied while a user moves the mobile printer freely (or the mobile printer moves in a self-propelled manner) over a plane such as a paper surface to scan the surface (freehand scanning).

Generally, an origin at which a handheld printer starts print processing is the position where a nozzle of a recording head is located at the time a user presses a print button.

However, the nozzle position of the recording head is not visible to the user at that time of pressing the print button, and therefore it is difficult for the user to accurately ascertain the print start position. It is likely that the user notices that the print start position deviates from the desired position only after printing is completed.

### SUMMARY

According to an embodiment of this disclosure, an improved printer includes a housing, a recording device disposed on a bottom of the housing and having a reference position, a sensor configured to detect a movement amount of the recording device, and circuitry configured to: set, in response to a print start instruction, a start position to a different position from the reference position in a scanning direction; and cause the recording device to start print processing of image data at the set start position, based on the movement amount detected by the sensor.

According to another embodiment, an improved printer includes a housing, a recording device disposed on a bottom of the housing and having a reference position, a sensor configured to detect a movement amount of the recording device, and circuitry configured to: set, in response to a print start instruction, a start position to one of the reference position and a different position from the reference position in a scanning direction; and cause the recording device to start print processing of image data at the set start position, based on the movement amount detected by the sensor.

According to yet another embodiment, an improved printer includes a housing, a recording device disposed on a bottom of the housing and having a reference position, and circuitry configured to: receive image data from an information processing apparatus that originates a print request; add margin data to the received image data; set, in response to a print start instruction, a start position to the reference position in the recording device; and start print processing of image data according to the image data including the margin data at the set start position.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a printing system according to an embodiment of the present disclosure;

FIGS. 2A, 2B, and 2C are views illustrating an exterior of a handheld printer according to an embodiment;

FIG. 3 is a block diagram illustrating a hardware configuration of the handheld printer, according to an embodiment;

FIG. 4 is a block diagram illustrating a hardware configuration of a control unit of the handheld printer, according to an embodiment;

FIG. 5 is a flowchart illustrating a printing process performed by the handheld printer, according to an embodiment;

FIGS. 6A, 6B, and 6C are schematic views illustrating a print setting screen of an image data providing device according to an embodiment of the present disclosure;

FIG. 7 is a flowchart illustrating an initial position setting process according to an embodiment;

FIGS. 8A and 8B are diagrams illustrating a concept of the initial position setting process illustrated in FIG. 7;

FIGS. 9A and 9B are diagrams illustrating another concept of the initial position setting process illustrated in FIG. 7;

FIGS. 10A and 10B illustrate an outermost end of a bottom of an apparatus housing;

FIGS. 11A and 11B also illustrate the outermost end of the bottom of the apparatus housing;

FIGS. 12A and 12B are illustrations of a print preview screen of the image data providing device, according to an embodiment;

FIGS. 13A and 13B illustrate editing of an image in accordance with print start position setting;

FIGS. 14A and 14B are plan views of a handheld printer provided with two print start buttons, according to an embodiment;

FIG. 15 is a flowchart illustrating an initial position setting and image processing according to another embodiment; and

FIGS. 16A and 16B are illustrations of a print result according to another embodiment.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, an image forming system according to an embodiment of this disclosure is described. As used herein, the singular forms “a”, “an”, and “the” are intended to include the plural forms as well, unless the context clearly indicates otherwise.

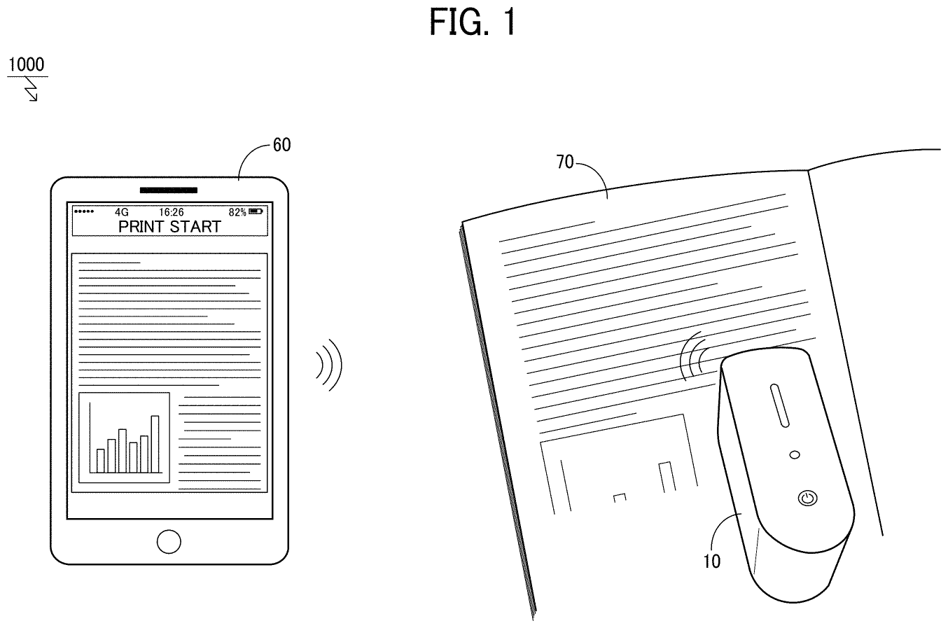

FIG. 1 is a schematic view illustrating a printing system 1000 according to an embodiment of the present disclosure. As illustrated in FIG. 1, the printing system 1000 includes a handheld printer 10, which is an example embodiment of a printer according to this disclosure, and an image data providing device 60. The printer is not limited to a handheld printer but includes a so-called self-propelled printer that is mounted on a moving device so that the printer performs printing while moving over a print target (a recording medium) while under external control.

The handheld printer 10 is a handheld printing apparatus and employs an inkjet printing method. The user can hold the handheld printer 10 and freely move the handheld printer 10 over a recording medium 70 (a print medium), thereby forming a desired image over the recording medium 70. The printing method of the handheld printer 10 is not limited to the inkjet method, and other printing methods, such as a dot impact method and a thermal transfer method, can be employed.

The image data providing device 60 is an information processing device that provides image data to be printed to the handheld printer 10. Thus, the information processing device originates a print request. Examples of the image data providing device 60 includes a smartphone, a tablet terminal, and a laptop computer.

The handheld printer 10 and the image data providing device 60 each have a wireless communication capability conforming to a predetermined wireless standard such as infrared communication, Bluetooth (registered trademark), Wi-Fi (registered trademark), etc., and exchange necessary information wirelessly. However, the present embodiment does not exclude configurations in which information is exchanged through wired communication.

The configuration of the printing system 1000 according to the present embodiment has been outlined above. Next, an external configuration of the handheld printer 10 according to the present embodiment is described.

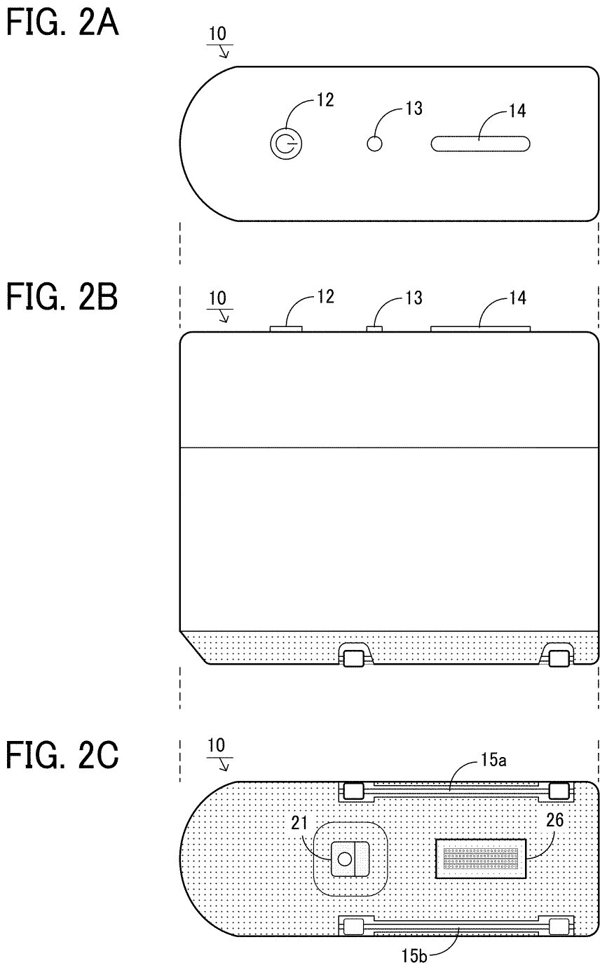

FIGS. 2A, 2B, and 2C are respectively a top view, a side view, and a bottom view of the handheld printer 10. As illustrated in FIG. 2B, the handheld printer 10 has a substantially rectangular parallelepiped housing. On a top side of the housing, a power button 12, a light emitting diode (LED) lamp 13, and a print start button 14 are disposed. A bottom side of the housing is opposed to a recording medium 70 during printing. On the bottom side, guide rollers 15a and 15b, a navigation sensor 21, and a recording head unit 26 are disposed. A gyro sensor (to be described later) is mounted inside the housing. The recording head unit 26 serves as a recording device.

The navigation sensor 21 has a mechanism similar o that of an optical mouse, to detect the amount of movement of the handheld printer 10. The navigation sensor 21 irradiates the recording medium 70 opposed thereto with light, photographs the reflected light, and calculates the amount of movement of the handheld printer 10 based on the difference in the acquired image data. More specifically, the movement amount of the handheld printer 10 mentioned here is a difference in position (ΔX, ΔY) of the navigation sensor 21 within a two-dimensional orthogonal coordinate system. The X axis and the Y axis of the two-dimensional orthogonal coordinate system (hereinafter “printer coordinate system”) correspond to the width direction and the longitudinal direction of the bottom side of the housing of the handheld printer 10, respectively.

The recording head unit 26 includes a recording head (the recording device). The recording head includes a plurality of nozzles (nozzle rows), and, with ink droplets discharged from the nozzles, forms a print image over the recording medium 70 opposed to the nozzles.

The guide rollers 15a and 15b enable smooth scanning of the recording medium. At the same time, the guide rollers 15a, and 15b serve as spacers to secure a gap between the nozzles of the recording head and the recording medium 70 necessary for printing.

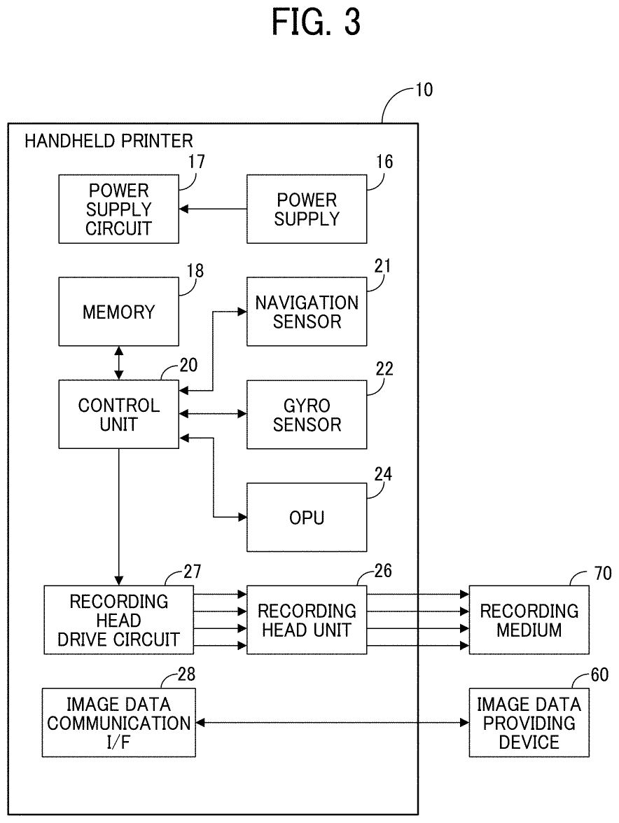

The external configuration of the handheld printer 10 according to the present embodiment has been described above. Subsequently, a hardware configuration of the handheld printer 10 is described below based on FIG. 3.

As illustrated in FIG. 3, in addition to the navigation sensor 21 and the recording head unit 26 described above, the handheld printer 10 includes a power supply 16, a power supply circuit 17, a memory 18, a control unit 20, a gyro sensor 22, an operation panel unit (OPU) 24 (an operation device), a recording head drive circuit 27, and an image data communication interface (I/F) 28, which are mounted inside the housing.

The power supply 16 supplies power used by the handheld printer 10 and is, for example, a secondary battery. The power supply circuit 17 controls power supply to each unit of the handheld printer 10.

The memory 18 is a storage device constructed of a read only memory (ROM) or a dynamic random access memory (DRAM). The ROM stores one or more programs for controlling the hardware of the handheld printer 10, drive waveform data for driving the recording head unit 26, data of initial setting information, and the like. The DRAM provides a program execution space and temporarily stores various data such as image data and the drive waveform data.

The control unit 20 is configured to control overall operation of the handheld printer 10, a detailed description of which is deferred.

The gyro sensor 22 is configured to detect a rotation angle of the handheld printer 10 that is a change in rotation angle from the previous access. Here, the rotation angle of the handheld printer 10 represents a rotation angle (Δθ) about an axis orthogonal to the printer coordinate system (plane coordinate system),

The OPU 24 is configured to accept an operation of the user and notify the user of the state of the handheld printer 10. In the present embodiment, the power button 12, the print start button 14, and the LED lamp 13 correspond to the OPU 24.

The recording head drive circuit 27 is configured to control the recording head of the recording head unit 26.

The image data communication I/F 28 is a data communication I/F conforming to a predetermined wireless standard. The handheld printer 10 receives data from the image data providing device 60 via the image data communication I/F 28.

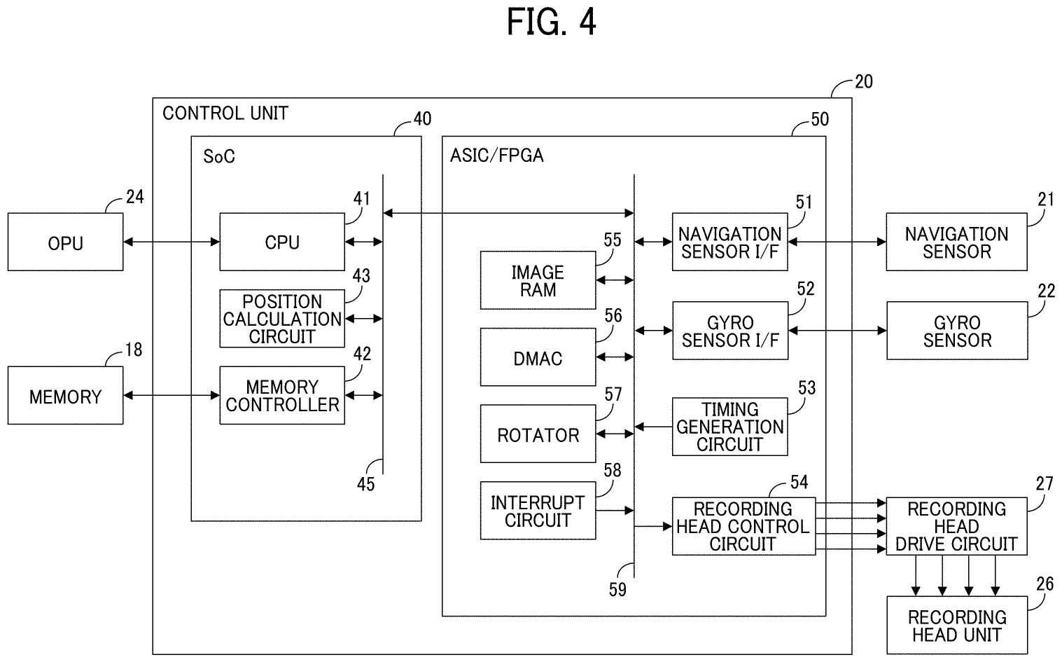

The hardware configuration of the handheld printer 10 according to the present embodiment has been described above. Subsequently, a hardware configuration of the control unit 20 of the handheld printer 10 is described below, referring to FIG. 4.

The control unit 20 includes a system on chip (SoC) 40 and an application-specific integrated circuit (ASIC)/field-programmable gate array (FPGA) 50. The SoC 40 includes a central processing unit (CPU) 41, a memory controller 42, and a position calculation circuit 43, which perform data communication via a bus 45.

The CPU 41 is configured to control overall operation of the handheld printer 10. The memory controller 42 is configured to control the memory 18.

The position calculation circuit 43 calculates the position coordinates (hereinafter “coordinates”) of the navigation sensor 21, using the movement amount (ΔX, ΔY) detected by the navigation sensor 21 and the rotation angle (Δθ) of the handheld printer 10 detected by the gyro sensor 22. Further, the position calculation circuit 43 calculates the coordinates of each nozzle of the recording head, based on the calculated coordinates of the navigation sensor 21.

The ASIC/FPGA 50 includes a navigation sensor I/F 51, a gyro sensor I/F 52, a timing generation circuit 53, a recording head control circuit 54, an image random access memory (RAM) 55, a direct memory access controller (DMAC) 56, a rotator 57, and an interrupt circuit 58, which perform data communication via a bus 59. The bus 59 is connected to the bus 45 so that the SoC 40 and the ASIC/FPGA 50 can perform data communication with each other.

The timing generation circuit 53 generates the timing at which the navigation sensor I/F 51 reads the output value (ΔX, ΔY) from the navigation sensor 21, the timing at which the gyro sensor I/F 52 reads the output value (Δθ) from the gyro sensor 22, and the timing at which the recording head discharges a liquid droplet. Further, the timing generation circuit 53 transmits these timings to the navigation sensor I/F 51, the gyro sensor I/F 52, and the recording head control circuit 54.

The navigation sensor I/F 51 performs data communication with the navigation sensor 21.

The gyro sensor I/F 52 performs data communication with the gyro sensor 22

The DMAC 56 reads out, from the memory 18 via the memory controller 42, data of an image to be formed by liquid discharged from the nozzles based on the coordinates of the nozzle calculated by the position calculation circuit 43 and stores the image data in the image RAM 55.

The image RAM 55 is a memory to temporarily store the image data read by the DMAC 56.

The rotator 57 rotates image data to be printed according to the position and the inclination of the recording head of the handheld printer 10. The rotator 57 acquires image data from the image RAM 55 and rotates the image data in accordance with the position and inclination of the recording head of the handheld printer 10. Then, the rotator 57 transmits the image data to the recording head control circuit 54 when the image data satisfies a predetermined condition required for ink discharge (hereinafter, “discharge condition”).

The recording head control circuit 54 controls the recording head drive circuit 27 to control the discharge operation of the recording head. The recording head control circuit 54 transmits, to the recording head drive circuit 27, a control signal for controlling the discharge operation of the recording head and image data to be printed at a timing designated by the timing generation circuit 53.

The interrupt circuit 58 transmits an interrupt signal to the SoC 40. The interrupt circuit 58 transmits, to the SoC 40, an interrupt signal indicating that the navigation sensor I/F 51 ends communication with the navigation sensor 21, and an interrupt signal for notification of status information such as an error.

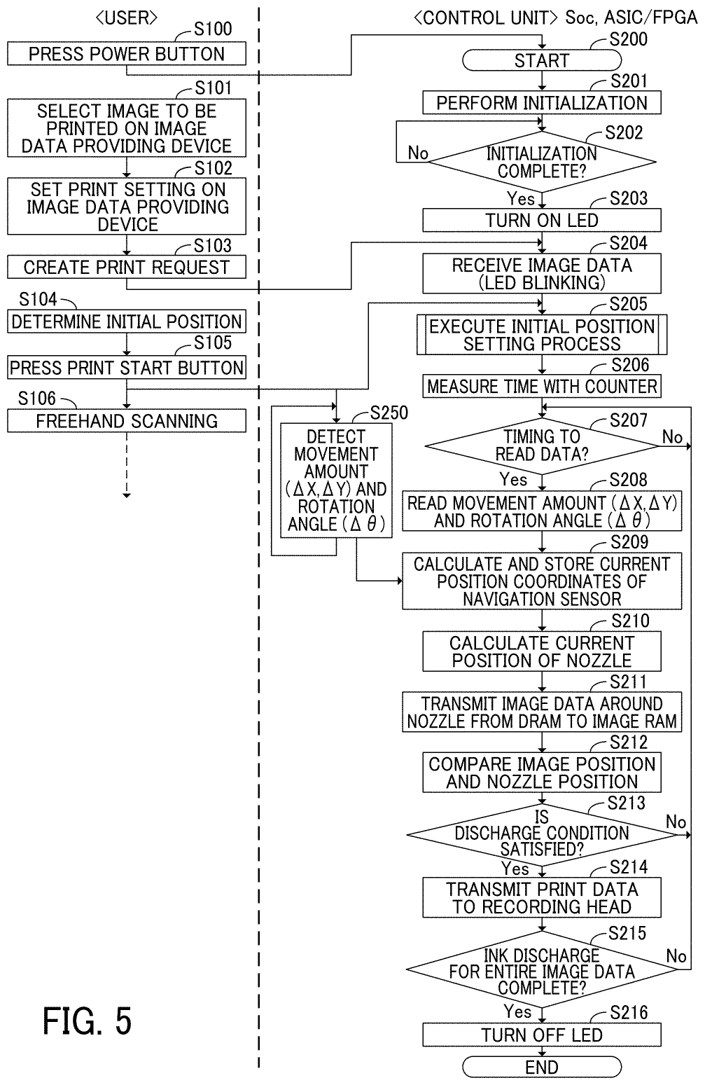

The hardware configuration of the control unit 20 of the handheld printer 10 has been described above. Subsequently, a printing process using the handheld printer 10 is described below based on the flowchart illustrated in FIG. 5. Note that, in FIG. 5, the operation of the user is illustrated on the left side of the broken line, and the operation of the control unit 20 is illustrated on the right side.

In response to pressing by the user of the power button 12 of the handheld printer 10 (S100), the control unit 20 receives power and starts the operation (S200). The SoC 40 executes initialization of each device (S201). When initialization is completed (Yes in S202), the SoC 40 turns on the LED lamp 13 (S203), to notify the user that printing is executable.

In response to the lighting, the user operates the image data providing device 60 to select an image to be printed (S101) and set various print settings on a predetermined setting screen provided by the image data providing device 60 (S102).

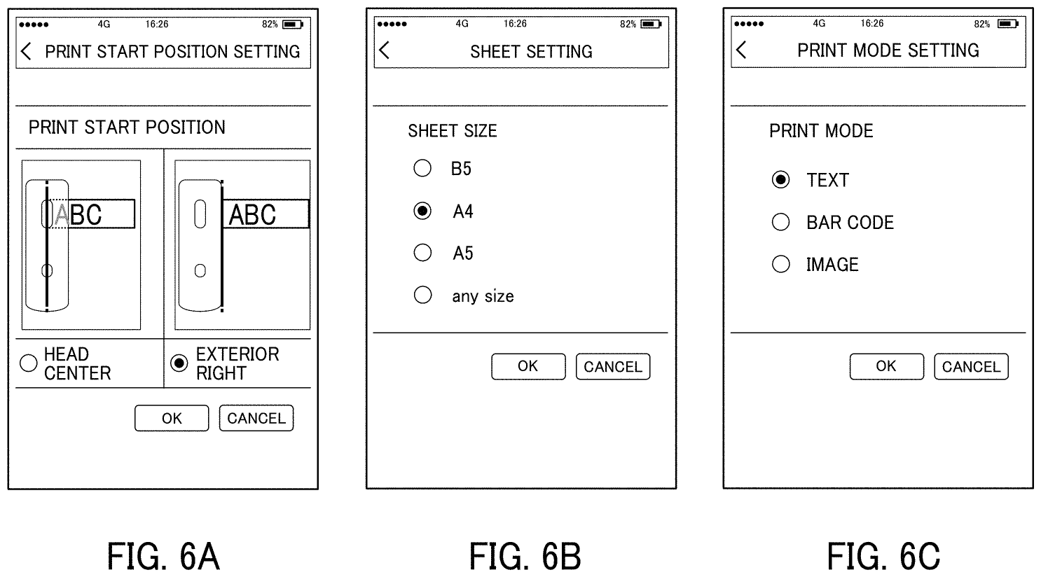

FIG. 6A illustrates an example of a print start position setting screen for setting the print start position. As illustrated in FIG. 6A, on the print start position setting screen according to the present embodiment, two types of print start positions, “head center” and “exterior right”, are presented in a selectable manner. Then, the user selects either “head center” or “exterior right” as the print start position. In the present embodiment, when “head center” is selected, a reference position (i.e., a reference nozzle position) of the recording head serves as a start position at which print processing is started (print start reference position). When “exterior right” is selected, the right side of the housing of the handheld printer 10 serves as the start position for print processing. Hardware and software to execute such processing together serve as a print start position setting unit.

The “reference position of the recording head” mentioned above represents the position of one of the plurality of nozzles of the recording head (hereinafter “reference nozzle position”) used as the reference position. Further, the above-mentioned “start position” represents a position where the calculation circuit or the like starts computing for printing (print processing) to be described later. However, the position where the print processing is started does not necessarily coincide with the position at which actual printing (ink is discharged from the recording head) is started.

Furthermore, the user selects the type of sheet via a sheet setting screen illustrated in FIG. 6B and selects a desired print mode from three print modes (a text printing mode, a bar-code printing mode, and an image printing mode) via a print mode setting screen illustrated in FIG. 6C.

The image printing mode corresponds to the freehand scanning by the user. In the image printing mode, printing is controlled to prevent bending and omission of the print image. The text printing mode is a print mode in which text is printed in one or more linear scanning passes. The text printing mode permits bending of the text to give priority to prevention of omission of a letter in printing. The bar-code printing mode is a print mode in which bar codes and quick response (QR) codes (registered trademark) are printed in a single linear scanning pass. The bar-code printing mode permits omission of an upper end and a lower end of the image to give priority to prevention of bending of the bar code and the like.

Alternatively, in another embodiment, default setting of the print start position can be either “exterior right” or “head center” in accordance with the print mode (text printing, bar-code printing, image printing) set by the user.

Referring back to FIG. 5, the process continues and, after finishing selection of the image to be printed and the print settings, the user operates the image data providing device 60 to request printing. In response to the request, the image data providing device 60 creates a print request that includes the selected image and the print setting specified (S103). Then, the image data providing device 60 transmits the generated print request to the handheld printer 10.

In response, while receiving the image data, the CPU 41 of the SoC 40 blinks the LED lamp 13 to notify the user of reception of the image data (S204).

Meanwhile, the user places the handheld printer 10 at a desired position on the recording medium over which printing is to be performed, sets that position as the initial position of printing (S104), and presses the print start button 14 (S105). Then, the user freely moves the handheld printer 10 (freehand scanning) over the recording medium to form an image (S106).

Meanwhile, in response to pressing of the print start button 14 (S105), the navigation sensor 21 and the gyro sensor 22 start detecting the movement amount (ΔX, ΔY) and the rotation angle (Δθ), respectively (S250). Simultaneously, the CPU 41 of the SoC 40 executes “initial position setting process” to store the coordinates of the initial position of the navigation sensor 21 in the memory 18 (S205), a detailed description of which is deferred. Hardware and software to enable such processing together serve as a sensor position information setting unit.

After storing the initial position of the navigation sensor 21, the CPU 41 instructs the navigation sensor I/F 51 to acquire the movement amount (ΔX, ΔY) from the navigation sensor 21 and instructs the gyro sensor I/F 52 to acquire the rotation angle (Δθ) from the gyro sensor 22. In response, the timing generation circuit 53 of the ASIC/FPGA 50 measures time with a counter (S206). The navigation sensor I/F 51 and the gyro sensor I/F 52 respectively wait for the arrival of timings to read the data of the navigation sensor 21 and the gyro sensor 22 (No in S207). Each time the respective timings arrive (Yes in S207), the navigation sensor I/F 51 and the gyro sensor I/F 52 respectively read the movement amount (ΔX, ΔY) and the rotation angle (Δθ) from the respective internal memories of the navigation sensor 21 and the gyro sensor 22 (S208).

The CPU 41 of the SoC 40 reads the movement amount (ΔX, ΔY) and the rotation angle (Δθ) from the navigation sensor I/F 51 and the gyro sensor I/F 52 of the ASIC/FPGA 50, respectively. Further, the CPU 41 calculates the current coordinates of the navigation sensor 21 based on the most recent coordinates of navigation sensor 21 (e.g., X_{S}, Y_{S}) stored in the memory 18 and the movement amount (ΔX, ΔY) and the rotation angle (Δθ) read in S208. The CPU 41 stores the calculated current coordinates in the memory 18 (S209). Hardware and software to enable such processing together serve as a calculation unit.

The CPU 41 of the SoC 40 transmits the calculated current coordinates of the navigation sensor 21 to the ASIC/FPGA 50. In response, the rotator 57 of the ASIC/FPGA 50 calculates coordinates of each nozzle of the recording head from the relative positions of the navigation sensor 21 and the recording head unit 26 (S210).

The DMAC 56 of the ASIC/FPGA 50 reads image data around each nozzle (i.e., adjacent image data) from the memory 18 (DRAM) based on the position information of each nozzle calculated in S210 and transmits the adjacent image data to the image RAM 55 (S211).

In response, the rotator 57 rotates the image data stored in the image RAM 55 in accordance with the position and the tilt of the recording head specified by the CPU 41 at the initialization. The rotator 57 compares the rotated image data and the coordinates of each nozzle (S212) and determines whether the discharge condition is satisfied (S213).

When the discharge condition is not satisfied (No in S213), the process returns to S207. When the discharge condition is satisfied (Yes at S213), the rotator 57 transmits the image data to the recording head control circuit 54 (S214). In response, the recording head control circuit 54 controls the recording head drive circuit 27 to discharge ink from the nozzles of the recording head onto the recording medium.

Then, the above-described process from S207 to S215 is repeated until ink discharge for entire image data is completed (No in S215). When ink discharge for the entire image data is completed (Yes in S215), the CPU 41 of the SoC 40 turns off the LED lamp 13 to notify the user of the end of ink discharge (S216).

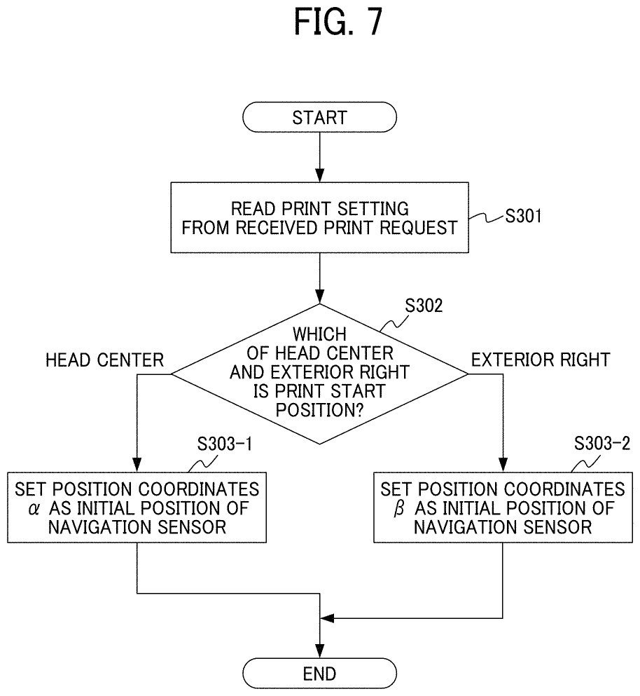

The printing process using the handheld printer 10 has been described above. Subsequently, descriptions are given below of the “initial position setting process” executed in response to the pressing of the print start button 14 with reference to the flowchart of FIG. 7.

In the initial position setting process, at S301, the control unit 20 reads the print setting included in the print request received from the image data providing device 60 (S301), At S302, the control unit 20 determines which of “head center” and “exterior right” is set as the print start position.

As a result, when the print start position is set to “head center”, the process proceeds to S303-1. Then, the control unit 20 reads out coordinates α from, e.g., the memory 18, sets the coordinates α as the initial position of the navigation sensor 21, and ends the process.

By contrast, when the print start position is set to “exterior right”, the process proceeds to S303-2. Then, the control unit 20 reads out coordinates β held in, e.g., the memory 18 as a value corresponding to “exterior right” alignment, sets the coordinates as the initial position of the navigation sensor 21, and ends the process.

The above-mentioned two coordinates α and β set as the initial position of the navigation sensor 21 are described below.

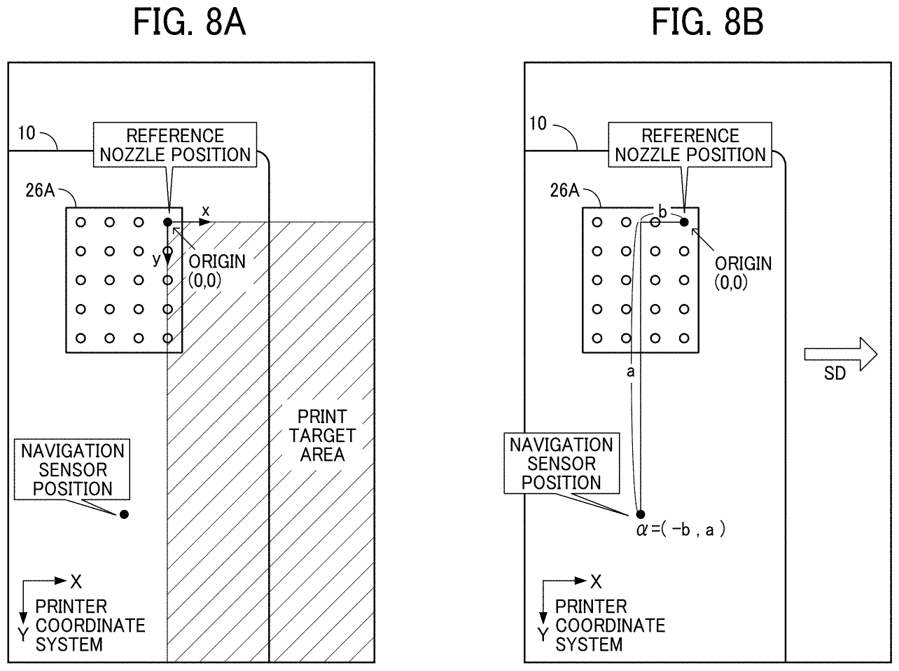

First, a description is given below of the coordinates a set as the initial position of the navigation sensor 21 in the case of “head center” alignment with reference to a conceptual diagram illustrated in FIGS. 8A and 8B. In FIGS. 8A and 8B, arrow SD indicates the scanning direction. In the present embodiment, where the print start position is set to “head center”, the reference nozzle position set in response to pressing of the print start button 14 is the start position. The reference nozzle position of the recording head (a recording head 26A in FIGS. 8A and 8B) at that time serves as the origin of a print target area in which printing is to be performed.

As illustrated in FIG. 8A, in the case of “head center” alignment, the print target area is an area defined by a two-dimensional orthogonal coordinate system in which the reference nozzle position is the origin (0,0). The x-axis direction and the y-axis direction of the two-dimensional orthogonal coordinate system respectively are set to the X-axis direction and the Y-axis direction of the printer coordinate system in response to pressing of the print start button 14.

When the position of the navigation sensor 21 and the reference nozzle position are as illustrated in FIG. 8B, the coordinates a of the navigation sensor 21 on the printer coordinate system whose origin (0,0) is the reference nozzle position are represented as (−b,a). That is, in the example illustrated in FIG. 8B, in the case of “head center” alignment, the coordinates of the initial position of the navigation sensor 21 are set to (−b,a), thereby setting the reference nozzle position to the origin (0,0) of the print target area.

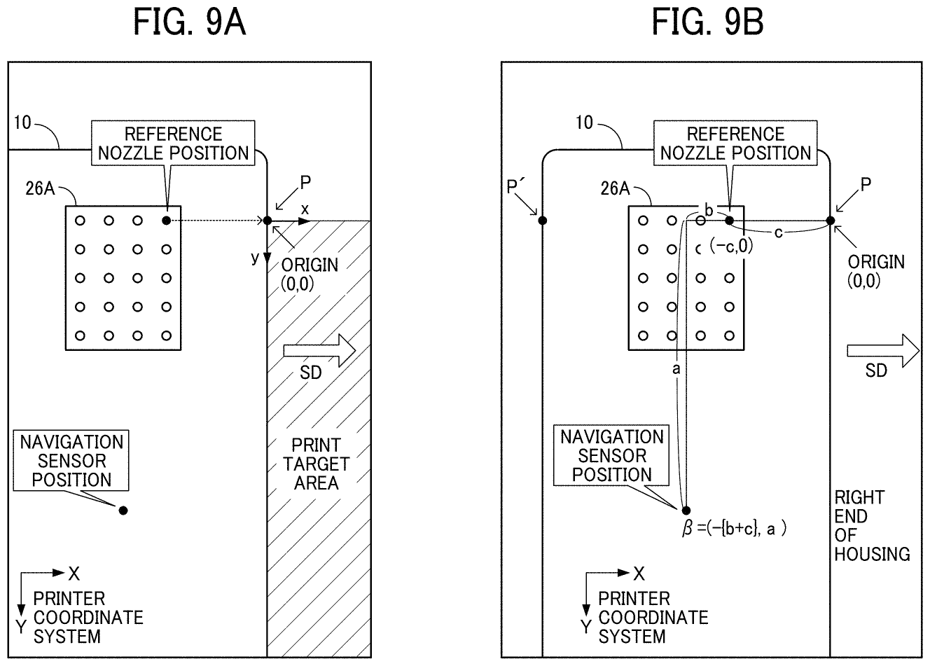

Next, the coordinates β set as an initial position of the navigation sensor 21 in the case of “exterior right” alignment are described referring to FIGS. 9A and 9B. In the present embodiment, when the print start position is set to “exterior right”, the right side of the housing of the handheld printer 10 is the start position, and the right side of the housing of the handheld printer 10 indicates the origin of the print target area in which printing is to be performed. That is, while the user moves the handheld printer 10 (or the handheld printer 10 may move in a self-propelled manner) in the scanning direction, the print processing starts in response to detection (based on the movement amount detected by the navigation sensor 21) that the nozzle has reached the position where the right side of the housing is located at the time of pressing of the print start button 14.

As illustrated in FIG. 9A, in the case of “exterior right” alignment, the print target area is an area defined by a two-dimensional orthogonal coordinate system whose origin (0,0) is a position P at which a virtual line extending from the reference nozzle position in the scanning direction (X-axis direction in the printer coordinate system) crosses the right-side outermost end of the bottom of the handheld printer 10. The x-axis direction and y-axis direction of the two-dimensional orthogonal coordinate system respectively coincide with the X-axis direction and Y-axis direction of the printer coordinate system at the time of pressing of the print start button 14.

Here, when the position of the navigation sensor 21 and the position P are as illustrated in FIG. 9B, the coordinates β of the navigation sensor 21 on the printer coordinate system whose origin (0,0) is the position P are represented as (−{b+c}, a). That is, in the example illustrated in FIG. 9B, in the case of “exterior right” alignment, the coordinates of the initial position of the navigation sensor 21 are set to (−{b+c},a), and the position P (the position of the outermost right side of the handheld printer 10) becomes the origin (0,0) of the print target area. In this case, the user can accurately ascertain the print start position with reference to the right side of the housing of the handheld printer 10. Hereinafter the housing of the handheld printer 10 is also simply referred to as “printer housing”.

In the present embodiment, the print start position may be set to “external left” alignment in the same manner as the “exterior right” alignment described above. In that case, the initial position of the navigation sensor 21 can be set, based on the relative positions of the navigation sensor 21 and a position P′ (illustrated in FIG. 9B), so that the origin (0,0) of a recording medium coordinate system matches the position P′ where the straight line extending in the scanning direction SD of the handheld printer 10 starting from the reference nozzle position intersects the outermost left end of the housing of the handheld printer 10. In this case, the user can ascertain the print start position with reference to the left end of the handheld printer 10. The process above can be also applied to a self-propelled printer in a similar manner.

In short, the handheld printer 10 according to the present embodiment can execute printing in the print target area whose origin is set to a predetermined visible position not obscured by the printer housing in response to the print start instruction (e.g., pressing of the print start button 14). Accordingly, the user can easily recognize the print start position and start printing from the desired position. Here, the “predetermined visible position not obscured by the printer housing” is at a predetermined distance from the reference nozzle position in the scanning direction and is a suitable position for the user to accurately ascertain the print start position. Therefore, the above-mentioned the “outermost end of the bottom of the printer housing” is to be interpreted in light of the above-mentioned purpose and thus should not be unnecessarily limited.

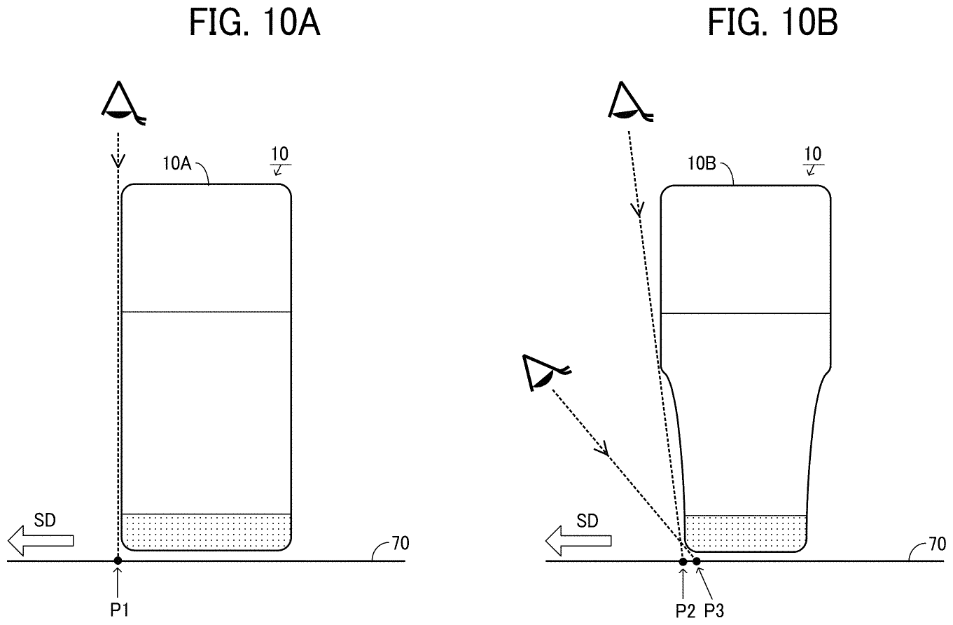

For example, as illustrated in FIG. 10A, when the width of the housing 10A of the handheld printer 10 is constant in the height direction, treating a position P1 on the recording medium 70 as the “outermost end of the bottom of the housing” satisfies the above purpose. By contrast, as illustrated in FIG. 10B, when the width of a housing 10B of the handheld printer 10 decreases from the top side to the bottom side, treating a position P2 on the recording medium 70 as the “outermost end of the bottom of the housing” satisfies the above purpose. Furthermore, assuming that the user performs printing looking at the bottom of the housing 10B of the handheld printer 10, treating a position P3 near the position P2 as the “outermost end of the bottom of the housing” also satisfies the above purpose.

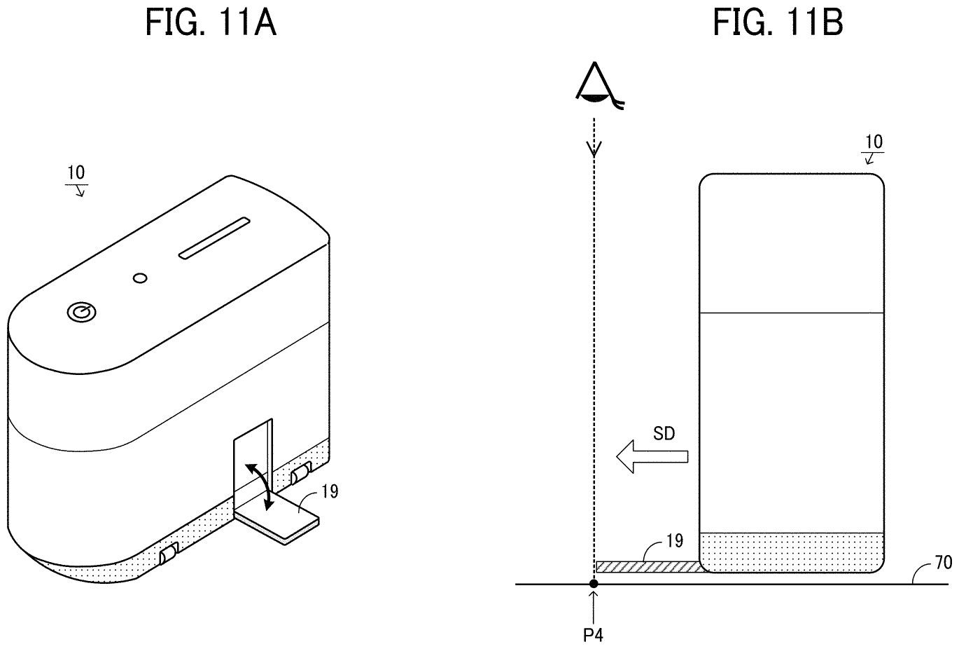

Furthermore, as illustrated in FIG. 11A, the handheld printer 10 can further include a guide 19 on a side of the housing to help the user to ascertain the print target area. In this case, as illustrated in FIG. 11B, to satisfy the above purpose, a position P4 indicated by a tip of the guide 19 extending in the scanning direction SD can be treated as the outermost end of the bottom of the printer housing. The guide 19 is coupled to the housing via a hinge on an extension line in the scanning direction when viewed from the recording head side. The guide 19 is retracted on the printer housing when printing is not performed.

Although example embodiments are described above, numerous additional modifications to the above-described embodiments and variations are possible.

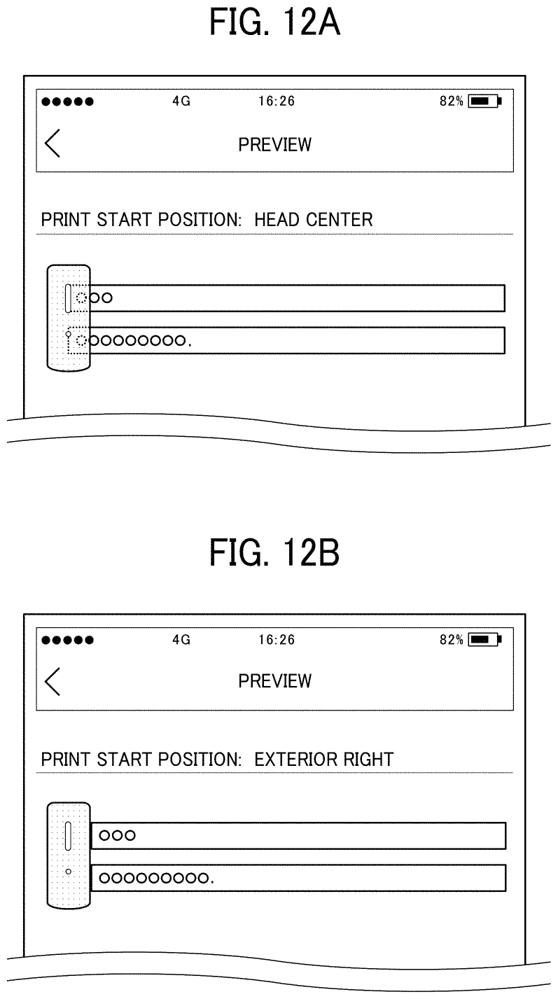

For example, the printing system 1000 can be configured to provide a preview of a print image corresponding to the print start position selected by the image data providing device 60. FIG. 12A illustrates an example of a preview screen when “head center” is selected as the print start position, and FIG. 12.B illustrates an example of a preview screen when “exterior right” is selected as the print start position.

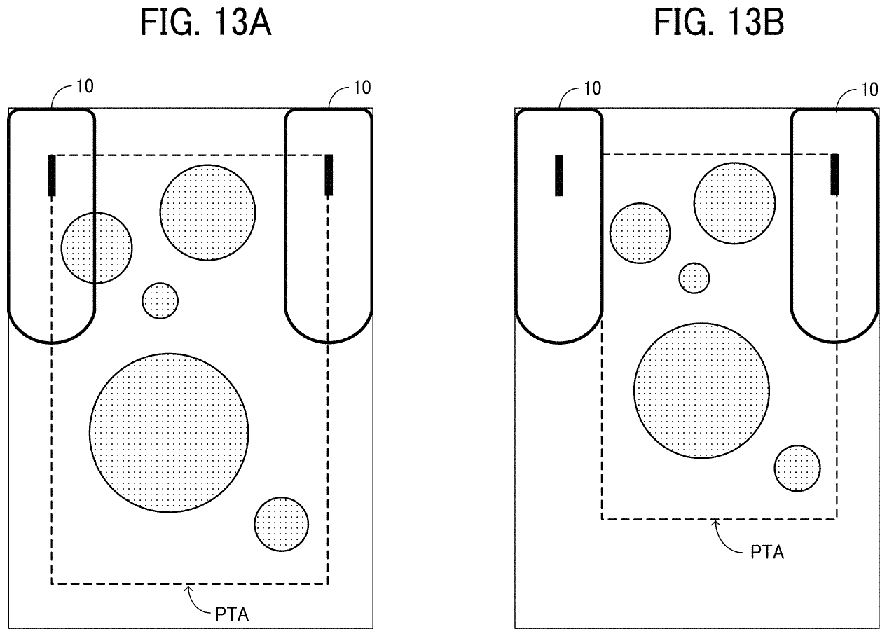

Further, the size of the image data to be printed may be changed according to the setting of the print start position. More specifically, the printing system 1000 can adopt a rule that the housing of the handheld printer 10 should not protrude from a regular size sheet in the scanning direction. In this case, as illustrated in FIGS. 13A and 13B, the size of the print target area varies depending on the setting of the print start position. As illustrated in FIG. 13A, when the print start position is set to “head center”, the width in the scanning direction of a print target area PTA is maximized. By contrast, as illustrated in FIG. 13B, when the print start position is set to “exterior right”, the width in the scanning direction of the print target area PTA is narrowed. In this case, for example, based on the selected print start position and the selected sheet size, the image data providing device 60 calculates the size of the print target area PTA. Then, in accordance with the calculated print target area PTA, the image data providing device 60 changes the size of the image to be formed based on the image data.

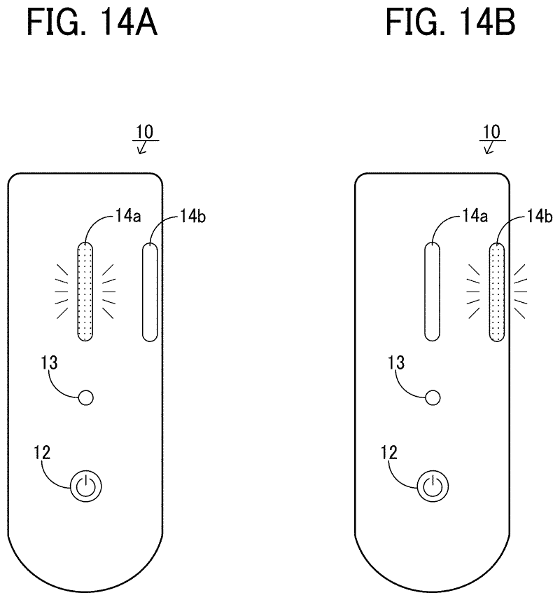

Alternatively, the setting of the print start position (that is, the setting of the origin of the print target area) may be received via the operation unit of the handheld printer 10. For example, as illustrated in FIGS. 14A and 14B, the handheld printer 10 can include two print start buttons 14a and 14b on the upper side of the housing. In this configuration, the handheld printer 10 accepts setting of “head center” alignment in response to pressing of the print start button 14a disposed at the center of the upper side and accepts setting of “exterior right” alignment in response to pressing of the print start button 14b adjacent to the upper right end.

Yet alternatively, the setting of the print start position (that is, the setting of the origin of the print target area) may be displayed on an indication device of the handheld printer 10. For example, the print start buttons 14a and 14b can incorporate LED lamps to become luminous buttons (i.e., indication devices). In this configuration, the handheld printer 10 turns on the print start button 14a in the case of “head center” setting as illustrated in FIG. 14A and turns on the print start button 14b in the case of “exterior right” setting as illustrated in FIG. 14B, so that the user can visually recognize the print start position set by the user.

Descriptions so far have been given of the embodiments in which, as illustrated in FIG. 9B, the position P different from the reference nozzle position by the distance c in the scanning direction SD is made the origin of the print target area so that the handheld printer 10 starts printing at the outermost end of the bottom of the housing. Alternatively, as another embodiment, image data to be printed may be processed to attain equivalent results or effects, as described below.

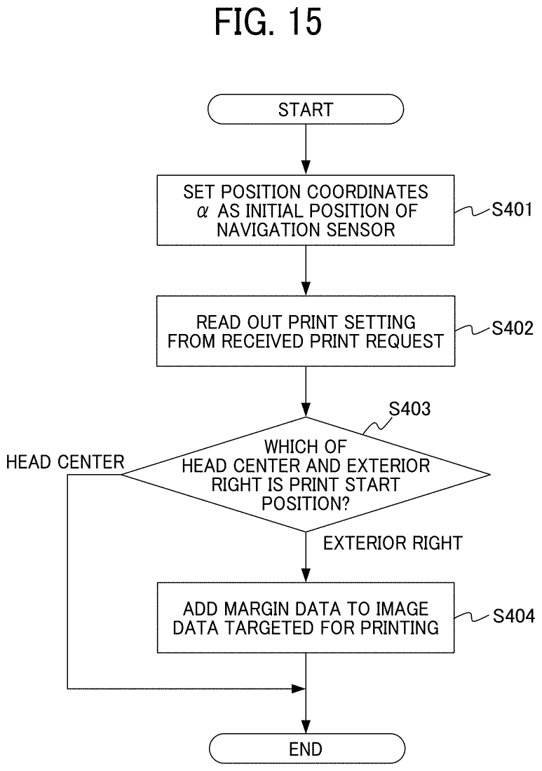

In another embodiment, in S205 of the flowchart illustrated in FIG. 5, instead of the “initial position setting process” illustrated in FIG. 7, “initial position setting and image processing process” is performed as illustrated in the flowchart in FIG. 15.

In the “initial position setting and image processing process”, first, the coordinates α stored in, the memory 18 are read out, and the coordinates a are set as the initial position of the navigation sensor 21 (S401). The coordinates a here are the coordinates (−b,a) calculated, as described above with reference to FIGS. 8A and 8B, so that the reference nozzle position in response to pressing of the print start button 14 becomes the origin (0,0) of the print target area.

Subsequently, the control unit 20 reads the print setting included in the print request received from the image data providing device 60 (S402). At S403, the control unit 20 determines which of “head center” and “exterior right” is set as the print start position.

As a result, when the print start position is set to “head center”, the process ends. On the other hand, when the print start position is set to “exterior right”, the process proceeds to S404.

In S404, the control unit 20 adds margin data of a predetermined width to the image data targeted for printing, included in the print request. Specifically, the margin data is added to a side of the image data extending in the direction orthogonal to the scanning direction. The size of the predetermined width here corresponds to the distance L in the scanning direction from the reference nozzle position to the outermost end of the bottom of the printer housing.

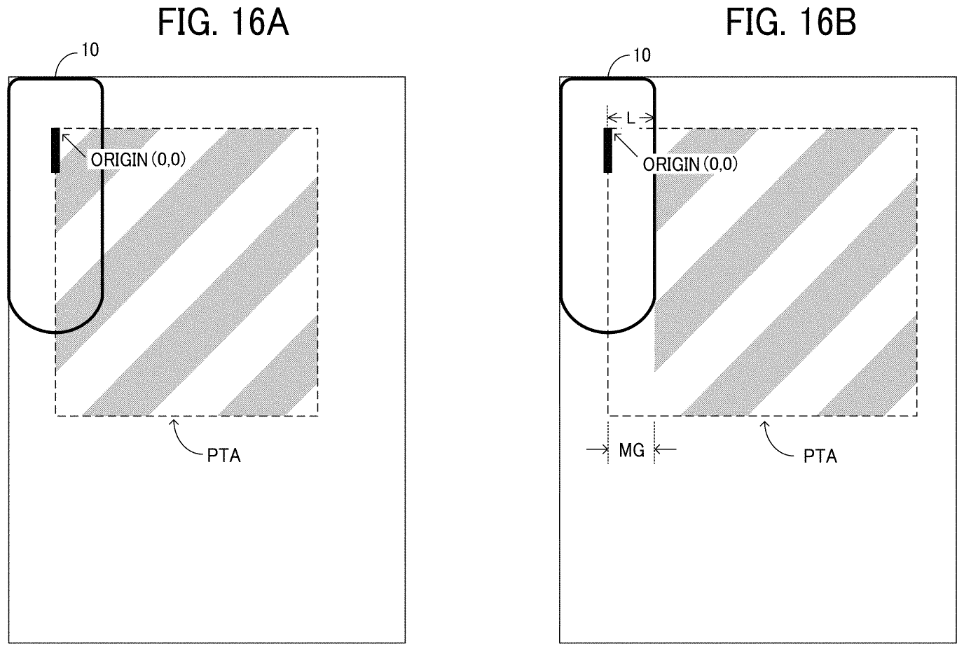

FIG. 16A illustrates the print result when the print start position is set to “head center”, and FIG. 16B illustrates the print result when the print start position is set to “exterior right”. As illustrated in FIG. 16B, in the present embodiment, when the setting is “exterior right”, margin data MG having the width L is added to the edge on the origin side (left side in FIGS. 16A and 16B) of image data. Then, even though the reference nozzle position is the origin of the print target area PTA, the actual printing is started from the outermost end of the bottom of the printer housing. Hardware and software to enable such processing together serve as a print executing unit to execute printing of image data to which margin data is added.

When the print start position is set to “exterior left”, margin data having the width L is added to the edge opposite the edge on the origin side of the image data (that is, the edge on the right side in FIGS. 16A and 16B).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Moreover, any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A printer comprising:
a housing;
a recording device disposed on a bottom of the housing and having a reference position;
a sensor configured to detect a movement amount of the recording device; and
circuitry configured to:
in response to a print start instruction, set a start position to a different position from the reference position in a scanning direction; and
cause the recording device to start print processing of image data at the set start position, based on the movement amount detected by the sensor.

2. The printer according to claim 1, wherein the different position is a position not obscured by the housing at a time of accepting the print start instruction.

3. The printer according to claim I, wherein the different position is a position at which an outermost end of the bottom of the housing crosses a virtual line extending in the scanning direction from the reference position in the recording device.

4. The printer according to claim 1, wherein the circuitry is configured to:
set a size of a print target area based on the set start position and a size of a recording medium on which printing is performed according to the image data; and
edit the image data to fit the print target area.

5. The printer according to claim 1, wherein the circuitry is configured to:
set position information of the sensor on a coordinate system in which the start position serves as an origin of a print target area;
calculate position information of the recording device based on the position information of the sensor and the movement amount of the recording device; and
execute print processing of the image data based on the position information of the recording device.

6. The printer according to claim 5, wherein the circuitry is configured to execute print processing of the image data in the print target area in which the origin is set to the start position.

7. A printer comprising:
a housing;
a recording device disposed on a bottom of the housing and having a reference position;
a sensor configured to detect a movement amount of the recording device; and
circuitry configured to:
in response to a print start instruction, set a start position to one of the reference position and a different position from the reference position in a scanning direction; and
cause the recording device to start print processing of image data at the set start position, based on the movement amount detected by the sensor.

8. The printer according to claim 7, further comprising an indication device configured to indicate setting of the start position.

9. The printer according to claim 7, further comprising an operation device configured to accept setting of the start position.

10. The printer according to claim 7, wherein the circuitry is configured to receive setting of the start position from an information processing device that originates a print request.

11. The printer according to claim 7, wherein the circuitry is configured to:
set a size of a print target area based on the set start position and a size of a recording medium on which printing is performed; and
edit the image data to fit the print target area.

12. The printer according to claim 7, wherein the circuitry is configured to:
set position information of the sensor on a coordinate system in which the start position serves as an origin of a print target area;
calculate position information of the recording device based on the position information of the sensor and the movement amount of the recording device; and
execute print processing of the image data based on the position information of the recording device.

13. The printer according to claim 12, wherein the circuitry is configured to execute the print processing of the image data in the print target area in which the origin is set to the reference position in response to setting of the start position to the reference position of the recording device.

14. A printer comprising:
a housing;
a recording device disposed on a bottom of the housing and having a reference position; and
circuitry configured to:
receive image data from an information processing device that originates a print request;
add margin data to the image data;
in response to a print start instruction, set a start position to the reference position in the recording device; and
start print processing of the image data including the margin data at e set start position.

15. The printer according to claim 14, wherein a width of the margin data in a scanning direction is equivalent to a distance in the scanning direction from the reference position in the recording device to a visible position not obscured by the housing.

16. The printer according to claim 15, wherein the visible position is a position along an outermost end of the bottom of the housing.
